(19) United States
(12) Patent Application Publication
(10) Pub. No.: US 2026/0279081 A1
(43) Pub. Date: Sep. 17, 2026

(54) ARTIFICIAL INTELLIGENCE IN CAMERA WITH AUGMENTED REALITY

(71) Applicant: SAMSUNG ELECTRONICS CO., LTD., Gyeonggi-Do (KR)

(72) Inventors: Deepali Vinay, Fremont, CA (US); Rahul Lokesh, Sunnyvale, CA (US)

(21) Appl. No.: 19/376,863

(22) Filed: Oct. 31, 2025

Related U.S. Application Data
(60) Provisional application No. 63/773,311, filed on Mar. 17, 2025.

(51) Int. Cl. G06V 20/70; G06T 19/00; G06V 20/20

(52) U.S. Cl. CPC G06V 20/70; G06T 19/006; G06V 20/20

(57) ABSTRACT

Artificial intelligence in camera with augmented reality (AR) includes detecting, by a device, an object in a camera feed concurrently with displaying the camera feed on a display screen of the device. A knowledge based is queried with a knowledge base query including a bounding box image of the object detected from the camera feed. A Vision Language Model (VLM) performs inference in response to a VLM request specifying the bounding box image of the object and a knowledge base result obtained from the knowledge base query. The inference generates a VLM result. An AR overlay is displayed on the display screen of the device over the camera feed. The AR overlay visually distinguishes the object within the camera feed and displays VLM information for the object specified by the VLM result.

### CROSS-REFERENCE TO RELATED APPLICATIONS

This application claims the benefit of U.S. Application Number 63/773,311 filed on Mar. 17, 2025, which is fully incorporated herein by reference.

### TECHNICAL FIELD

This disclosure relates to fault detection systems and, more particularly, to an artificial intelligence (AI)-enabled mobile fault detection system capable of providing guidance with augmented reality support.

### BACKGROUND

In many different industries, workers, including technical staff, are often responsible for solving issues in the field. For example, workers in various manufacturing industries, in datacenters, or the like, are often the first line of defense against issues that prevent equipment from operating at peak performance. “Hands-on” work of these individual keeps equipment working as expected to consistently meet daily production requirements and/or other performance metrics. Maintaining the equipment often requires that the workers have direct interaction with complex machinery and navigate intricate technological processes while maintaining a steady pace to achieve defined production/performance goals. Clear and concise task instructions are a necessary ingredient of achieving these goals.

In many cases, organizations provide workers with video training for specific tasks. On-site, hands-on training is often lacking. This may be especially true for hazardous tasks. While workers may have access to particular information, often such information is fragmented and exists across many different platforms. For example, some information may be available in user manuals for the equipment, other information may be available in training videos, other information may be maintained in a Wiki, and still other information may only be learned by experience in the field. The lack of on-site and hands-on training often leads to extensive time spent troubleshooting, worker error, and, in some cases, may pose safety concerns, thereby highlighting the need for improved task support systems.

### SUMMARY

In one or more examples, a method includes, within a device, detecting an object in a camera feed concurrently with displaying the camera feed on a display screen of the device. The method includes querying a knowledge base with a knowledge base query. The knowledge base query includes a bounding box image of the object detected from the camera feed. The method includes performing inference using a Vision Language Model (VLM) in response to a VLM request specifying the bounding box image of the object and a knowledge base result obtained from the knowledge base query. The inference generates a VLM result. The method includes displaying, on the display screen of the device, an augmented reality (AR) overlay over the camera feed. The AR overlay visually distinguishes the object within the camera feed and displays VLM information for the object specified by the VLM result.

The foregoing and other implementations can each optionally include one or more of the following features, alone or in combination. Some example implementations include all the following features in combination.

In some aspects, the knowledge base result included in the VLM request includes an image of the object in a normal configuration and an image of the object in a faulty configuration.

In some aspects, the VLM is trained to compare the bounding box image of the object with the image of the object in the normal configuration and the image of the object in the faulty configuration.

In some aspects, the method includes submitting an updated bounding box image of the object to the VLM. The updated bounding box image is obtained subsequent to a corrective action for the object. The VLM is configured to evaluate whether a detected fault with the object is rectified based on the updated bounding box image compared, at least in part, with the image of the object in the normal configuration and the image of the object in the faulty configuration.

In some aspects, the knowledge base result included in the VLM request includes data extracted from one or more of a specification for the object or a manual for the object.

In some aspects, the method includes establishing a communication session between the device and a communication device of an expert user of the object. The method includes conveying, from the device, a view of the camera feed and the AR overlay from the display screen of the device to the communication device of the expert user for display on a display screen of the communication device.

In some aspects, the method includes establishing a communication link between the device and the object and obtaining status information from the object over the communication link.

In some aspects, the method includes performing at least one of displaying the status information as part of the AR overlay or including the status information in the VLM request submitted to the VLM.

In some aspects, the method includes receiving a user query directed to the object and including the user query within the VLM request.

In one or more examples, a device includes a camera configured to generate a camera feed. The device includes a display screen configured to display the camera feed. The device includes an object detector configured to detect an object in the camera feed concurrently with the display of the camera feed on the display screen. The object detector generates a bounding box image of the object. The device includes a retrieval system configured to query a knowledge base with a knowledge base query including the bounding box image of the object. The device includes a Vision Language Model (VLM) configured to perform inference in response to a VLM request generated by the retrieval system to generate a VLM result. The VLM request includes the bounding box image of the object and a knowledge base result obtained from the knowledge base query. The device includes an augmented reality (AR) module configured to display, on the display screen, an AR overlay over the camera feed. The AR overlay visually distinguishes the object within the camera feed and displays VLM information for the object specified by the VLM result.

The foregoing and other implementations can each optionally include one or more of the following features, alone or in combination. Some example implementations include all the following features in combination.

In some aspects, the knowledge base result included in the VLM request includes an image of the object in a normal configuration and an image of the object in a faulty configuration.

In some aspects, the VLM is trained to compare the bounding box image of the object with the image of the object in the normal configuration and the image of the object in the faulty configuration.

In some aspects, the retrieval system is capable of submitting an updated bounding box image of the object to the VLM. The updated bounding box image is obtained subsequent to a corrective action for the object. The VLM is configured to evaluate whether a detected fault with the object is rectified based on the updated bounding box image compared, at least in part, with the image of the object in the normal configuration and the image of the object in the faulty configuration.

In some aspects, the knowledge base result included in the VLM request includes data extracted from one or more of a specification for the object or a manual for the object.

In some aspects, the device includes a communication subsystem capable of establishing a communication session between the device and a communication device of an expert user of the object. The communication subsystem is capable of conveying a view of the camera feed and the AR overlay from the display screen of the device to the communication device of the expert user for display on a display screen of the communication device.

In some aspects, the device includes a communication subsystem capable of establishing a communication link between the device and the object and obtaining status information from the object over the communication link.

In some aspects, the AR module is capable of performing at least one of displaying the status information as part of the AR overlay or including the status information in the VLM request submitted to the VLM.

In some aspects, the device is capable of receiving a user input specifying a query directed to the object and including the user query within the VLM request.

In one or more examples, a system includes a display screen, a hardware processor, and one or more computer-readable storage mediums. The one or more computer-readable storage mediums are configured to store a knowledge base and a Vision Language Model (VLM). The one or more computer-readable storage mediums further have program instructions stored thereon to cause the hardware processor to perform operations. The operations include detecting an object in a camera feed concurrently with displaying the camera feed on the display screen. The operations include querying the knowledge base with a knowledge base query including a bounding box image of the object detected from the camera feed. The operations include performing inference using the VLM in response to a VLM request specifying the bounding box image of the object and a knowledge base result obtained from the knowledge base query. The inference generates a VLM result. The operations include displaying, on the display screen, an augmented reality (AR) overlay over the camera feed. The AR overlay visually distinguishes the object within the camera feed and displays VLM information for the object specified by the VLM result.

The foregoing and other implementations can each optionally include one or more of the following features, alone or in combination. Some example implementations include all the following features in combination.

In some aspects, the knowledge base result included in the VLM request includes an image of the object in a normal configuration and an image of the object in a faulty configuration.

In one or more examples, a computer program product includes a computer readable storage medium having program instructions embodied therewith. The program instructions are executable by computer hardware, e.g., a hardware processor, to cause the computer hardware to execute the operations described within this disclosure.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the implementations to only the examples shown. Various aspects and advantages will become apparent upon review of the following detailed description and upon reference to the drawings.

FIG. 1 illustrates an example of an architecture for an Artificial-Intelligence (AI)-enabled fault detection system.

FIG. 2 illustrates an example method of operation for the architecture of FIG. 1.

FIG. 3 illustrates example equipment that may require troubleshooting and/or diagnostics.

FIG. 4 illustrates an example of a device configured to execute the architecture of FIG. 1 in implementing a fault detection system.

FIG. 5 illustrates an example state of the device of FIG. 4 in which bounding boxes are displayed as part of an Augmented Reality (AR) overlay indicating detected objects.

FIG. 6 illustrates an example dataset generated by the object detector of FIG. 1.

FIG. 7 illustrates an example state of the device of FIG. 4 where a particular component is visually distinguished from other detected components via the AR overlay.

FIG. 8 illustrates an example state of the device of FIG. 4 subsequent to initiation of a troubleshooting session as described in connection with FIG. 7.

FIG. 9 illustrates an example state of the device of FIG. 4 in which a user is submitting a user input.

FIG. 10 illustrates an example state of the device of FIG. 4 subsequent to the user submitting the user input illustrated in FIG. 9.

FIG. 11 illustrates an example state of the device of FIG. 4 showing example GUI control(s).

FIG. 12 illustrates an example state of the device of FIG. 4 engaged in a communication session.

FIG. 13 illustrates an example state of the device of FIG. 4 subsequent to resolution of a fault with a component.

FIG. 14 is an example implementation of the device of FIG. 4 that is capable of including and/or executing the architecture of FIG. 1.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to fault detection systems and, more particularly, to an artificial intelligence (AI)-enabled fault detection system capable of providing guidance with augmented reality support. The fault detection system may be a mobile system. The disclosed technology provides methods, systems/devices, and computer program products capable implementing AI-powered support and/or diagnostics of equipment. The disclosed technology is capable of capturing a camera feed (e.g., images or frames of a video) in real-time and detecting objects in the frames. An Augmented Reality (AR) overlay may be displayed over the captured, or live, camera feed. The AR overlay is capable of providing information to the user regarding any objects detected within the camera feed. The AR overlay may be part of a user interface of the system through which the user may interact to obtain additional information relating to the objects detected in the camera feed.

As an illustrative and non-limiting example, a user may require assistance troubleshooting particular equipment. The user may utilize a device to capture frames/video of the equipment. Objects, e.g., components of the equipment, may be automatically recognized by the device. These components may be visually highlighted on the display screen of the device through the use of the generated AR overlay. The user may interact with the device by way of touch input using the AR overlay, textual input, and/or speech input to obtain additional information from a knowledge base pertaining to any recognized objects. The user may also initiate queries regarding recognized objects to a Vision Language Model (VLM). In some examples, the device is capable of automatically detecting which component of the equipment is experiencing a fault or error condition.

In one or more aspects, the user may choose to initiate contact with an expert, e.g., another user, directly through the device. In establishing a communication session with a communication device of the expert, the view and/or information presented to the user via the display screen of the device may be shared with the communication device of the expert thereby allowing the expert to have access to the same information, e.g., same camera feed and AR overlay, as the user in real-time for purposes of assisting and/or troubleshooting the equipment.

In one or more aspects, the device may communicate over a communication network with one or more of the particular component(s) detected in the camera feed. In one or more other aspects, the user may select one or more components detected in the camera feed. In either case, the device is capable of directly communicating with one or more components of the equipment including any that may be selected by the user to obtain status information directly from such components in real-time.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

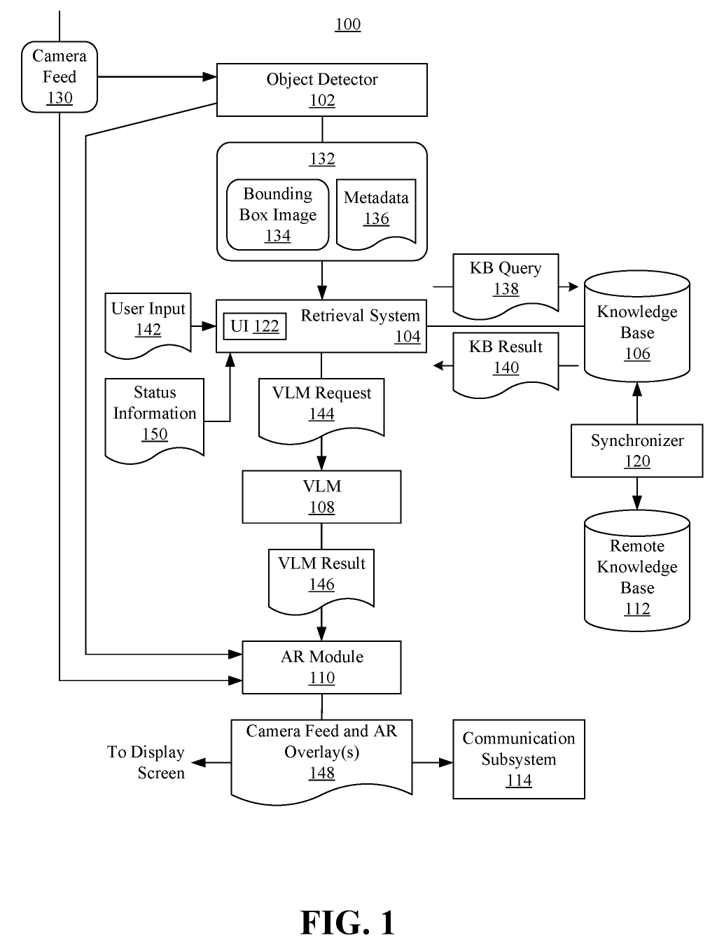

FIG. 1 illustrates an example of an architecture 100 for an AI-enabled fault detection system. In one or more examples, architecture 100 is implemented as an executable architecture, e.g., program code, that may be executed by one or more hardware processors (e.g., central processing units (CPUs) and/or hardware accelerators) of a data processing system. In one or more other examples, architecture 100 is implemented as an electronic system that may include a plurality of interconnected circuits as represented by the various blocks of FIG. 1, whether contained in a same integrated circuit (IC) device or implemented in a plurality of IC devices. The IC device(s), which may include hardware processors, may be configured to perform the various operations described herein. Examples of the IC devices may include, but are not limited to, Application-Specific ICs (ASICs), programmable IC devices (e.g., Field Programmable Gate Arrays or “FPGAs”), Graphics Processing Unit(s) (GPUs), Digital Signal Processors (DSPs), neural processors, Systems-on-Chip, hardware accelerators, and/or any combination of the foregoing.

In one or more examples, architecture 100 may be implemented as, or included within (e.g., embedded within), a workstation, a desktop computer, a computer terminal, a mobile computer, a laptop computer, a netbook computer, a tablet computer, a smart phone, a personal digital assistant, a smart watch, smart glasses, a gaming device, a set-top box, a television, a smart television, information appliance, streaming device, IoT device, server, a virtual reality (VR) system, an augmented reality (AR) system, a mixed reality (MR) system, an extended reality (XR) system, a metaverse system, a wearable device (e.g., smart glasses and/or goggles), or the like.

Architecture 100 can include an object detector 102, a retrieval system 104, a knowledge base 106, a Vision Language Model (VLM) 108, an AR module 110, and a communication subsystem 114. In the examples described herein, architecture 100 is capable of operating in real-time or in substantially real-time. In some examples, all of the various functions and/or subsystems illustrated as part of architecture 100 in FIG. 1 may be implemented locally within the particular system/device in which architecture 100 is embedded.

In the example of FIG. 1, a synchronizer 120 and a remote knowledge base 112 are illustrated. Synchronizer 120 and remote knowledge base 112 may be implemented in an external system and may be considered separate from architecture 100. Synchronizer 120 and remote knowledge base 112 may be coupled to the device executing architecture 100 through a communication network, whether wired or wireless. In the example, remote knowledge base 112 may be implemented as a primary knowledge base and maintained in a different system than the device that includes knowledge base 106, which may operate as a secondary or synchronized mirror of remote knowledge base 112. Synchronizer 120 is capable of synchronizing changes from remote knowledge base 112 to knowledge base 106 from time-to-time, in real-time as remote knowledge base 112 is updated, periodically, or the like.

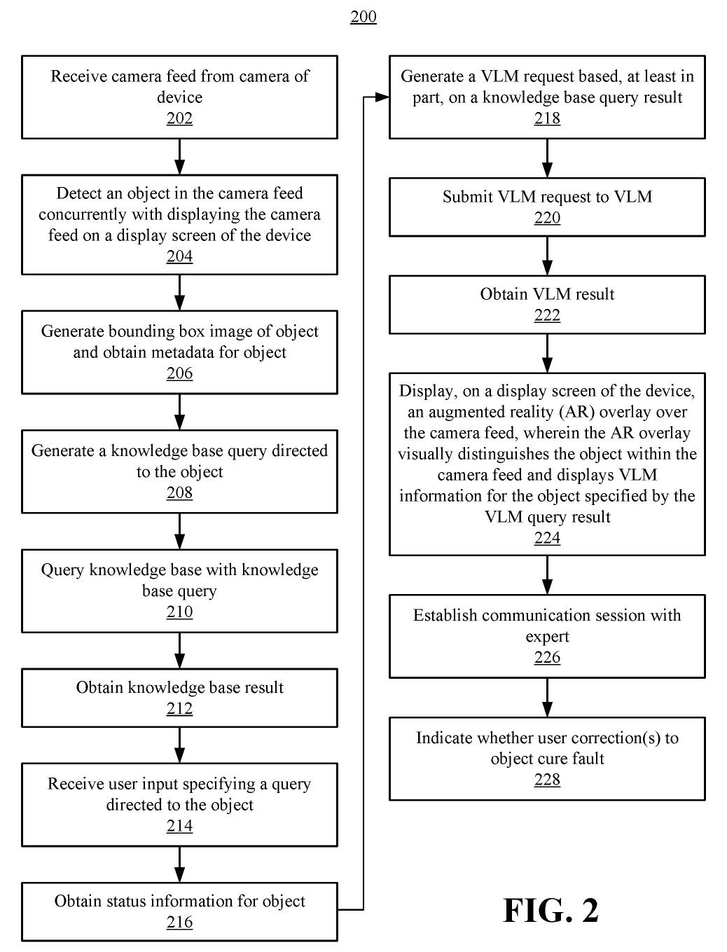

FIG. 2 illustrates an example method 200 of operation for architecture 100 of FIG. 1. Method 200 of FIG. 2 is described with reference to architecture 100 of FIG. 1. Accordingly, in block 202, object detector 102 is capable of receiving a camera feed 130. Camera feed 130 includes a plurality of sequential or time ordered frames captured by a camera of the device. Each frame, for example, may be considered a digital image that may be part of video captured by the camera. Camera feed 130 may be a live camera feed of images (e.g., video) captured by a camera of a device in real-time.

In block 204, object detector 102 is capable of detecting one or more objects within the frames of camera feed 130. It should be appreciated that while method 200 of FIG. 2 is described generally in the context of detecting an object, the disclosed technology is capable of detecting a plurality of different objects within one or more frames of the camera feed 130. The object detection implemented by object detector 102 may be performed concurrently with displaying camera feed 130 on a display screen of the device in real-time or in substantially real-time.

Object detector 102 is capable of performing a variety of different operations. These operations may be performed on frames concurrently with the frames being displayed or subsequent to display of the frames. For example, for a received frame of camera feed 130, object detector 102 is capable of detecting whether particular objects are present within the frame. Object detector 102 may be configured or trained to detect one or more different types of objects from frames of camera feed 130. For example, in order to troubleshoot particular equipment, object detector 102 may be trained to specifically detect various components of the equipment from frames of camera feed 130.

Object detector 102 may be implemented using any of a variety of different object detection technologies. For example, object detector 102 may be implemented as a feature-based detector, as a deep learning-based detector such as a Region-Based Convolutional Neural Network (CNN), a Fast Recurrent-CNN (CNN), a You Only Look Once (YOLO) detector, or as a Single Shot MultiBox Detector (SSD), or as an instance segmentation model such as Mask R-CNN. The examples provided herein are for purposes of illustration and not limitation. Object detector 102 may be implemented using one or more or a combination of the aforementioned technologies to implement functions such as visual object detection, localization, labeling, and/or tracking.

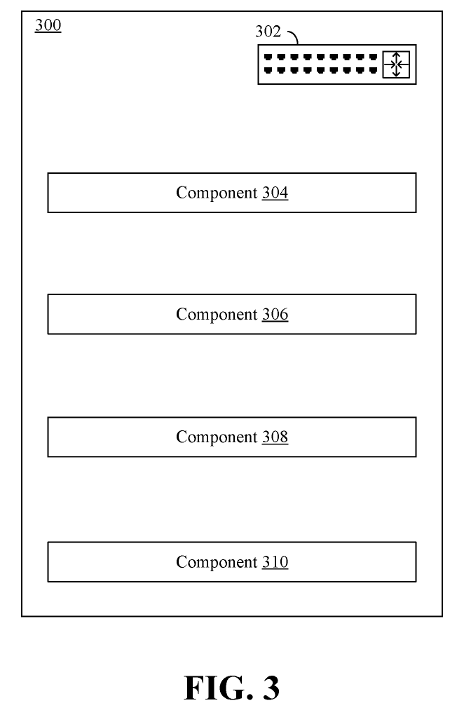

FIG. 3 illustrates an example equipment 300 that may require troubleshooting and/or diagnostics. For purposes of illustration, equipment 300 may be illustrative of a rack, e.g., a system, of electronic gear such as computing and/or communication equipment. For purposes of illustration, each piece of electronic gear is labeled as a component (e.g., components 302, 304, 306, 308, and 310). Examples of different components 302-310 that may be included in equipment 300 may include, but are not limited to, computers/servers, switches, data storage devices, network adapters, and/or the like. As noted, object detector 102 may be trained to detect the appearance of components 302-310 within frames of camera feed 130.

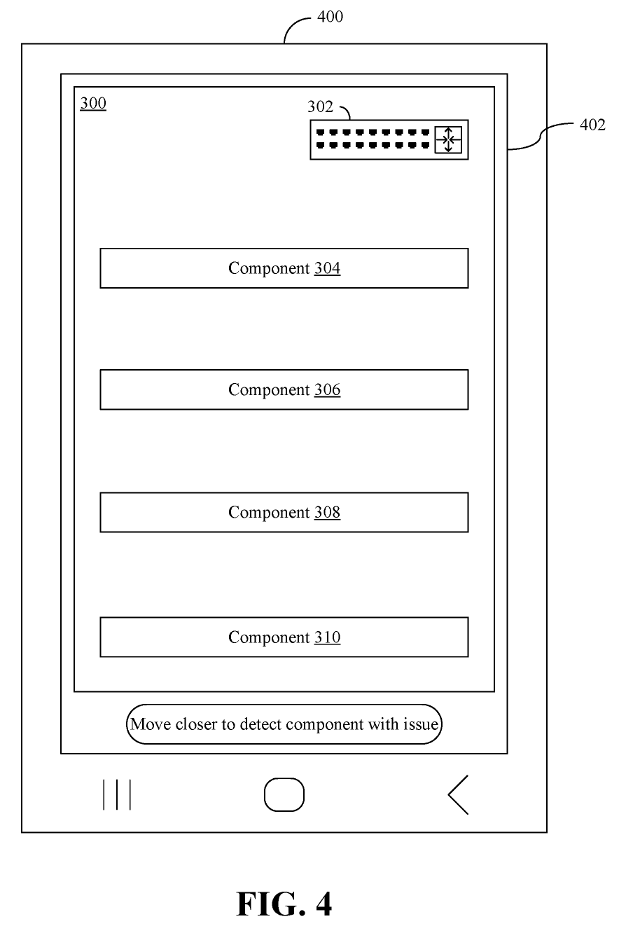

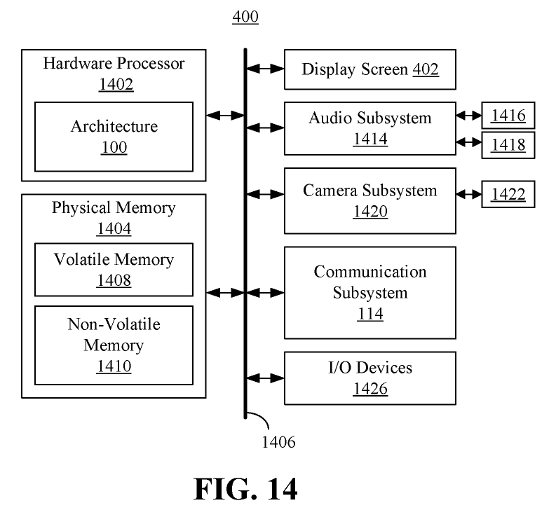

FIG. 4 illustrates an example of a device 400 that is configured to execute architecture 100 of FIG. 1. An example hardware architecture of device 400 is described in greater detail in connection with FIG. 14. In the example of FIG. 4, device 400 may be embodied as a mobile device such as a smartphone or a tablet. Device 400 includes a display screen 402. A user of device 400 is tasked with checking operation of equipment such as equipment 300 of FIG. 3 in the field. As such, the user has activated a camera (not shown) of device 400 and is or has captured a frame or frames as part of camera feed 130 that includes equipment 300 in frame. In the example, device 400 provides feedback to the user. In this case, the feedback is displayed on display screen 402 as a message asking the user to move closer to the equipment being captured in frame of the camera.

In block 206, for each object detected in camera feed 130, object detector 102 is capable of generating a bounding box image of the object and obtaining metadata for the object. For example, object detector 102 is capable of localizing each object that is detected within the respective frame. Object detector 102 is capable of segmenting the frame using bounding boxes or other techniques such as masks to detect a location of each detected object within the frame thereby providing a spatial relationship between the objects detected within each respective frame. In one or more aspects, object detector 102 is capable of classifying each visual object detected by assigning one or more classifications to each visual object detected. The classification may indicate the type of the object or otherwise specify what the object is. Further, object detector 102 is capable of tracking the visual objects from one frame of camera feed 130 to the next.

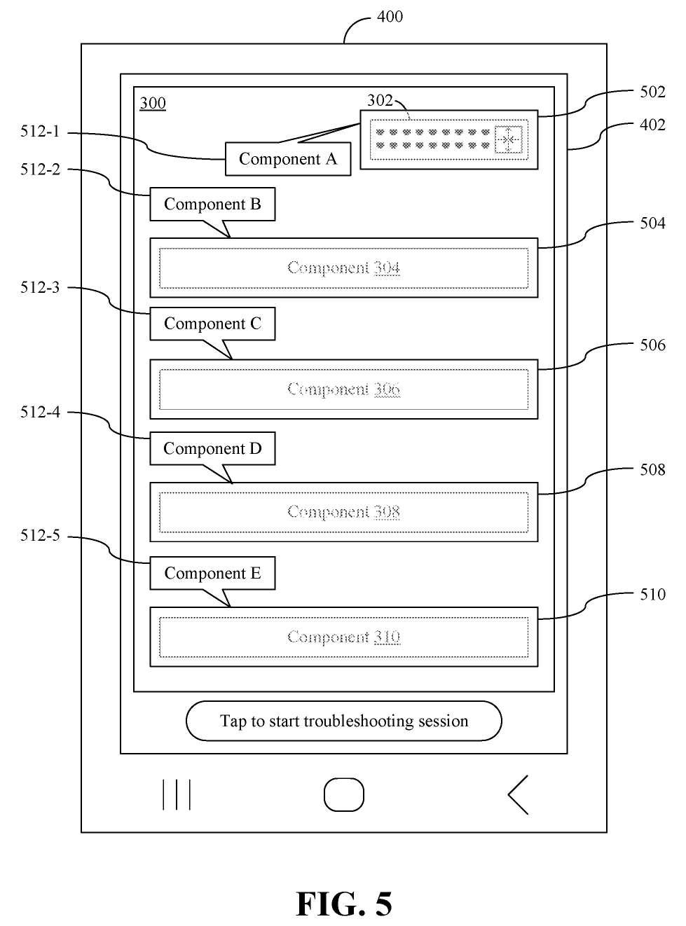

FIG. 5 illustrates an example state of device 400 of FIG. 4 in which bounding boxes are displayed as part of an AR overlay indicating the detected objects. In the example, object detector 102 has detected components 302, 304, 306, 308, and 310 within one or more frames of camera feed 130 and has illustrated the detection of the respective components by placing bounding boxes 502, 504, 506, 508, and 510 over and/or encompassing each respective component. Architecture 100, e.g., AR module 110, is capable of placing and displaying the bounding boxes as part of an AR overlay that is displayed over or atop of camera feed 130 as displayed on display screen 402. The AR overlay is capable of displaying information such as component labels 512 (e.g., 512-1, 512-2, 512-3, 512-4, and 512-5), error indicators, and/or step-by-step instructions that may be superimposed over camera feed 130.

In one or more examples, as part of performing object detection, object detector 102 is capable of retrieving certain metadata pertaining to each detected object. For example, as object detector 102 has been trained to detect particular objects, in response to detecting such object or instance of such an object in camera feed 130, object detector 102 is capable of outputting a label or textual description, e.g., a name, of the detected object. In the example, as part of the AR overlay that is displayed, AR module 110 is capable of displaying metadata for the detected objects such as names, classifications, or other data for the detected objects stored within object detector 102. In the example, AR module 110 is displaying labels 512 within the AR overlay with each label specifying an item of metadata obtained from performing object detection. For purposes of illustration, the item of metadata is the name of the component, though it should be appreciated that other types of metadata may be stored within object detector 102 in association with the various objects that object detector 102 is capable of detecting. Further, object detector 102, in response to detecting an object within camera feed 130, any stored information for that type of object may be returned and displayed within a label 512.

In one or more examples, as illustrated in FIG. 1, object detector 102 is capable of outputting dataset(s) 132 for camera feed 130. In the example, a dataset 132 may be output for each object detected within camera feed 130. Each dataset 132 for a given object detected in camera feed 130 may include a bounding box image 134 and metadata 136. Appreciably, object detector 102 may output a plurality of such datasets 132. In the example, object detector 102 is capable of segmenting each frame based on the bounding boxes surrounding the detected objects of the frame. Object detector 102 is capable of extracting each detected object as a bounding box image. A bounding box image is an image that is a cropped version of the frame from which the bounding box image was extracted. The bounding box image may be cropped along the boundary of the bounding box. In this regard, the bounding box image represents a portion of the image from which the bounding box image was extracted and includes a detected object therein. Each bounding box image containing a detected object, as extracted from a frame of camera feed 130, exists as an image independently of the frame from which the bounding box image was extracted.

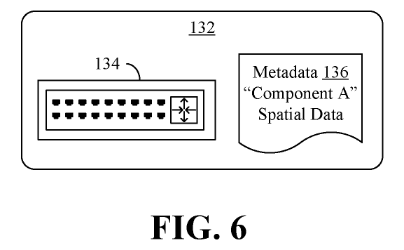

FIG. 6 illustrates an example of dataset 132 as generated by object detector 102 of FIG. 1. In the example, dataset 132 includes a bounding box image 134 and metadata 136 for the bounding box image. More particularly, the metadata 136 is for the detected object pictured within the bounding box image 134.

In the example of FIG. 6, bounding box image 134 is for component A (e.g., component 302) and includes component A pictured therein. As noted, bounding box image 134 may be generated by cropping a frame such as the view illustrated in FIG. 6 along the boundary of bounding box 502. In the example, metadata 136 for component A may include any information and/or labels associated with the object as detected by object detector 102. In one or more examples, metadata 136 may include spatial information for bounding box image 134. The spatial information of metadata 136 may specify the location of component A as detected within a frame of camera feed 130. The spatial information may be a coordinate location of the center of bounding box 502, may specify corner information (e.g., coordinates of two opposing corners) for bounding box 502, a quadrant of the frame in which the object was detected, or the like.

Continuing with FIGS. 1 and 2, retrieval system 104 receives datasets 132. In block 208, retrieval system 104 is capable of generating a knowledge base query 138 for knowledge base 106. Knowledge base 106 may be stored locally on device 400. In the example, knowledge base 106 may store a variety of different information for components of equipment 300. For example, for one or more components or each component of equipment 300, knowledge base 106 may store manual(s), specifications, a record or description of a correct configuration of the component for operation in equipment 300, one or more images of the component in a normal configuration, and/or one or more images of the component in a faulty configuration. The phrase “normal configuration,” in reference to the component, refers to a configuration, e.g., wiring, settings, switch settings, etc., of the component as configured for fault free operation and/or operation as intended in equipment 300. The phrase “faulty configuration,” in reference to the component, refers to a configuration, e.g., wiring, settings, switch settings, etc., of the component that is known to induce faults, errors, or otherwise operate in a manner not intended when operating as part of equipment 300.

In one or more examples, retrieval system 104 is capable of generating knowledge base query 138 to include dataset 132 for a particular detected object such as component A. In that case, knowledge base query 138 will include bounding box image 134 of component A and metadata 136 for component A.

In one or more example implementations, no interaction from the user in terms of selecting a particular component is required. That is, the operations described thus far in connection with FIG. 2 may be performed automatically simply by the user invoking the diagnostic mode on device 400 and pointing the camera of the device to equipment 300. The disclosed technology is capable of automatically and proactively detecting components of the equipment. In some examples, the device also is capable of detecting faults in components and obtaining or suggesting solutions for curing the detected faults.

In one or more examples, retrieval system 104 may generate multiple knowledge base queries for knowledge base 106. For example, retrieval system 104 may generate a knowledge base query for each object detected and submit each such knowledge base query to knowledge base 106.

In block 210, retrieval system 104 queries query knowledge base 106 with knowledge base query 138 (or each such knowledge base query). Retrieval system 104 submits knowledge base query 138 to knowledge base 106. Considering component A as the detected object, retrieval system 104 is capable of submitting the bounding box image 134 of component A and the metadata 136 for component A to knowledge base 106 as a query. Knowledge base 106 may execute the query and return a knowledge base result 140 to retrieval system 104. Knowledge base result 140 may include one or more data items found to match or relate to knowledge base query 138.

In one or more examples, retrieval system 104 may submit a knowledge base query for each object detected in camera feed 130. In other cases, e.g., where a user selects a particular object by touching the object, for example, as displayed on display screen 402, retrieval system 104 may submit a knowledge base query only for the user selected object.

As noted, object detection performed by object detector 102 determines the bounding box image of the detected component and a component name. In one or more examples, retrieval system 104 is capable of querying knowledge base 106 as follows. Retrieval system 104 is capable of retrieving information specific to the detected object, e.g., component A, from one or more information manuals or other resources for component A. Retrieval system 104 is also capable of retrieving closest matching data for the component detected, e.g., based on image and/or metadata searching of knowledge base 106. As noted, retrieval system 104 may obtain information such as a description of ideal configuration of component A, normal condition images, and/or fault condition images.

In one or more examples, knowledge base 106 may compare/match bounding box image 134 specified by knowledge base query 138 with stored images (e.g., images of components with normal configurations and/or image of components with faulty configurations). Further, knowledge base 106 may compare/match metadata 136 with stored metadata. Accordingly, in block 212, retrieval system 104 receives knowledge base result 140. In the example, knowledge base result 140 may specify images, e.g., images of normal configurations and/or faulty configurations, of knowledge base 106 found to match bounding box image 134. Knowledge base result 140 may also include information associated with matched images such as descriptions of known issues of the components in the images, the user manual, and/or specification of the matched images and/or metadata, as well as such information or portions thereof extracted from the sourced noted and stored in knowledge base 106.

It should be appreciated that the information specified by knowledge base result 140 may be labeled such that each image and the accompanying information is labeled as, for example, a normal configuration or a faulty configuration. Further, more detailed labeling may be included that describes the particular faulty configuration and/or provides other attributes relating to the condition of the component as included in the respective images. In block 212, retrieval system 104 obtains knowledge base result 140.

In block 214, architecture 100 may optionally receive a user input 142 that specifies a query directed to the detected object. In one or more examples, user input 142 is a user-spoken utterance, e.g., speech from a user. Device 400, for example, may include a microphone and audio processing hardware capable of receiving audio such as speech and digitizing the audio. In this example, retrieval system 104 may include a user interface 122 that is capable of performing speech recognition to convert the user-spoken utterance into text. In some examples, user interface 122 may include a natural language understanding processor that is capable of extracting semantic content or meaning from the speech recognized text.

In one or more other examples, user input 142 may be a textual input with user interface 122 receiving the textual input from device 400. For example, a user may type text directly into device 400. User interface 122 optionally may process the textual input through a natural language understanding processor to extract semantic content or meaning from the textual input. In the example, user input 142 may contain or specify a user query pertaining to the detected object or a particular detected object.

In block 216, device 400 optionally may establish a communication link with the detected object, e.g., component 302, and obtain status information from the object over the communication link. For example, architecture 100, via communication subsystem 114, may establish a wired or wireless communication link with the detected object. In one or more examples, based on the object detection and recognizing the object in camera feed 130 as component A, architecture 100 is capable of establishing the communication link with component A based on stored or obtained network information for component A. In response to establishing the communication link with component A, device 400 is capable of receiving status information 150 for the component that indicates whether the component is working normally or experiencing a fault or error condition. For example, the status information 150 may include any error codes that are generated by component 302. Status information 150 may be included in the VLM request described hereinbelow in connection with block 218.

In one or more other examples, device 400 may include one or more hardware sensors such as light sensors, heat sensors, and sound sensors (e.g., a microphone) through which device 400 may obtain additional status information, referred to herein as sensor-based status information, for component 302. Information obtained from the sensors, e.g., light information, heat information, sound information, or the like may be obtained by device 400 for component 302. Such sensor-based status information may be included in the VLM request described hereinbelow in connection with block 218.

In one or more other examples, status information, whether obtained via a communication link directly from component 302 and/or sensor-based status information, may be mapped to the particular component to which the information pertains, e.g., component 302 in this case. The information also may be displayed as part of an AR overlay such that the information is presented in a manner that clearly links the information with component 302. For example, the status information may be included in label 512-1 for component 302 so that the user is able to readily determine that the additional displayed information pertains to component 302.

In block 218, retrieval system 104 is capable of generating a VLM request 144 based, at least in part, on knowledge base result 140. VLM request 144 is a request for inference performed by VLM 108. For example, retrieval system 104 may formulate VLM request 144 to specify dataset 132 (e.g., bounding box image 134 and metadata 136 for a detected object) and the knowledge base result 140 for the detected object. In some examples, retrieval system 104 is capable of formulating VLM request 144 to ask VLM 108 to compare and contrast the dataset 132 with the labeled information corresponding to knowledge base result 140 to infer the particular problem or issue, e.g., to diagnose, an issue with the detected object.

In one or more examples, in the case where user input 142 is received, retrieval system 104 also may include information from or derived from user input 142 within VLM request 144. For example, retrieval system 104 may include only the text specified by user input 142 in VLM request 144 with the other data (e.g., omit any semantic content). In one or more other examples, retrieval system 104 may include a combination of the text from the user input 142 and semantic content derived from natural language understanding processing of user input 142 with the other data. In one or more other examples, VLM request 144 may include only the semantic content derived from natural language understanding processing of user input 142 with the other data (e.g., omit the verbatim text of user input 142). In any case, by including user input 142 and/or information derived from user input 142 within VLM request 144 with the other items of information described, retrieval system 104 is provided with additional contextual information as to the purpose of the query and the type of information that is desired in response from the user.

As discussed, retrieval system 104 is also capable of including status information 150 and/or sensor-based status information within VLM request 144. Thus, VLM request 144 may include one or more or any combination of bounding box image 134, metadata 136, user input 142, semantic content of user input 142, status information 150, sensor-based status information, and/or knowledge base result 140.

In block 220, retrieval system 104 is capable of submitting VLM request 144 to VLM 108. VLM 108 is capable of performing inference in response to VLM request 144 using the information specified therein as input features. In block 222, AR module 110 receives or obtains a VLM result 146 from VLM 108. In the example, AR module 110 may also receive camera feed 130 and information from object detector 102 thereby allowing AR module 110 to correlate objects detected in camera feed 130 (e.g., locations and bounding boxes of the detected objects) with information specified in VLM result 146.

In block 224, architecture 100, e.g., AR module 110, is capable of displaying, on display screen 402 of device 400, an AR overlay over or atop of camera feed 130. In FIG. 1, the camera feed and AR overlay is illustrated as element 148 and is directed to the display screen. Camera feed and AR overlay 148 also may be directed to communication subsystem 114 in some cases described herein below in greater detail. In any case, the AR overlay is superimposed over camera feed 130 and is capable of visually distinguishing the object within camera feed 130 from other objects. AR overlay is also capable of displaying any VLM information for the object that may be specified by VLM result 146. In the example, element 148 may represent a sequence of frames that may be played or rendered as a video in which the frames of camera feed 130 are combined or added with frames of the AR overlay resulting in a composite frame that specifies both the frames of camera feed 130 and the AR overlay superimposed thereon.

In one or more examples, VLM 108 is a locally executed or operated system. That is, VLM 108 may execute or reside within the particular system or device, e.g., device 400, in which architecture 100 is embedded. VLM 108 is capable of performing inference on VLM request 144. VLM 108 is a mixed mode system that is capable of processing inference requests that specify both textual information and visual information such as images. VLM 108 performs inference based on received VLM request 144. VLM 108 may be a general purpose VLM and/or one that includes additional training and/or has been trained to respond and/or troubleshoot particular equipment installations and components of the equipment installation. As a rudimentary illustration of the inference process performed by VLM 108, VLM 108 may be trained, at least in part, to compare the bounding box image of the object with the image of the object in a normal configuration and the image of the object in a faulty configuration to detect whether the detected component, e.g., component A in this case, is experiencing a fault. Other information included in VLM request 144 may be used by VLM 108 in generating VLM result 146 also.

In one or more examples, VLM 108 may include a vision encoder, a multi-modal fusion layer or layers, and a Large Language Model (LLM). The vision encoder is capable of generating an encoding from a visual input such as image(s)/frame(s), video, and/or bounding box images. The encoding is sometimes referred to as image tokens. The multi-modal fusion layer is configured to translate the encoding of the visual input into a format that a text-based LLM can understand and process in combination with text input. The LLM is capable of receiving text input and is trained to use the combined data, e.g., the fused data as output from the multi-modal fusion layer, to generate a coherent text-based response.

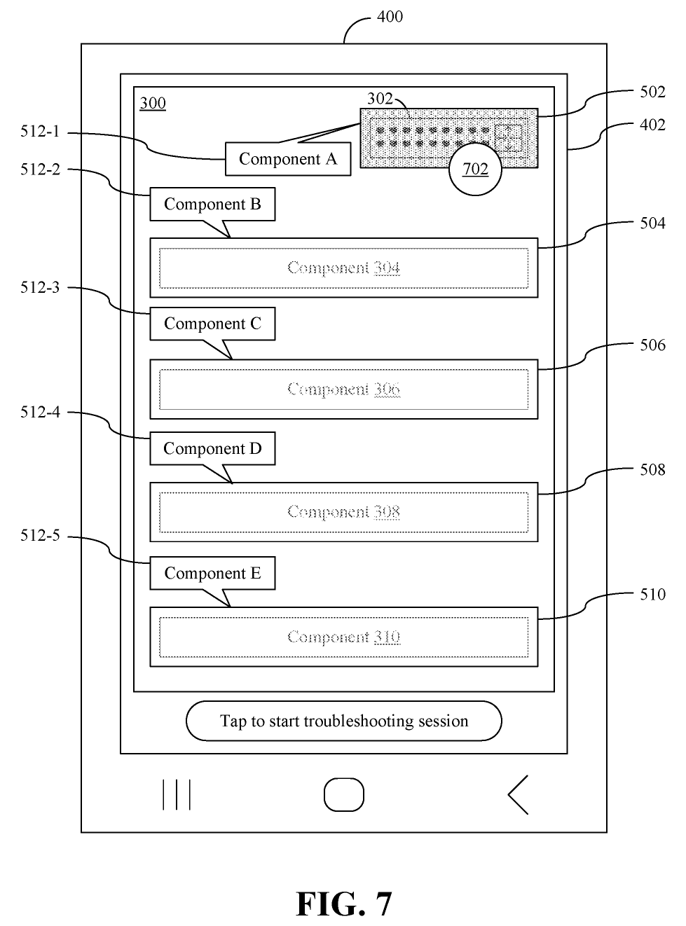

FIG. 7 illustrates an example state of device 400 where component 302 is visually distinguished from other detected components via the AR overlay generated by AR module 110. In one or more examples, architecture 100 has automatically detected an anomaly or fault with component 302 based on VLM result 146. That is, VLM result 146 indicates that component 302 has an anomaly or fault. In response, architecture 100 has visually differentiated bounding box 502 from the other bounding boxes. For example, bounding box 502 may be given a particular color such as red, or a particular texture, while other bounding boxes for components for which an anomaly or fault was not detected are shaded with a different color such as green or a different texture.

The disclosed technology is capable of detecting a fault of a component automatically. In some examples, the fault may be detected using the VLM as described. In other examples, the fault may be detected based on status information obtained from the component. In other examples the fault may be detected based on sensor-based status information. Appreciably, fault detection may be performed based on one or more or any combination of the different types of information obtained by architecture 100.

In one or more other examples, the user may select component 302 via a touch interface using a touch 702. In that case, the user selection may be received at various times during the flow illustrated in FIG. 2. For example, the user selection of component 302 may be received subsequent to object detection to drive the remainder of the flow so that the later actions pertain only to component 302. In another example, user selection of component 302 may be received subsequent to architecture 100 detecting a fault with component 302 as part of further troubleshooting of component 302 with the user as illustrated in the AR overlay presented to the user with the instruction “Tap to start troubleshooting session.”

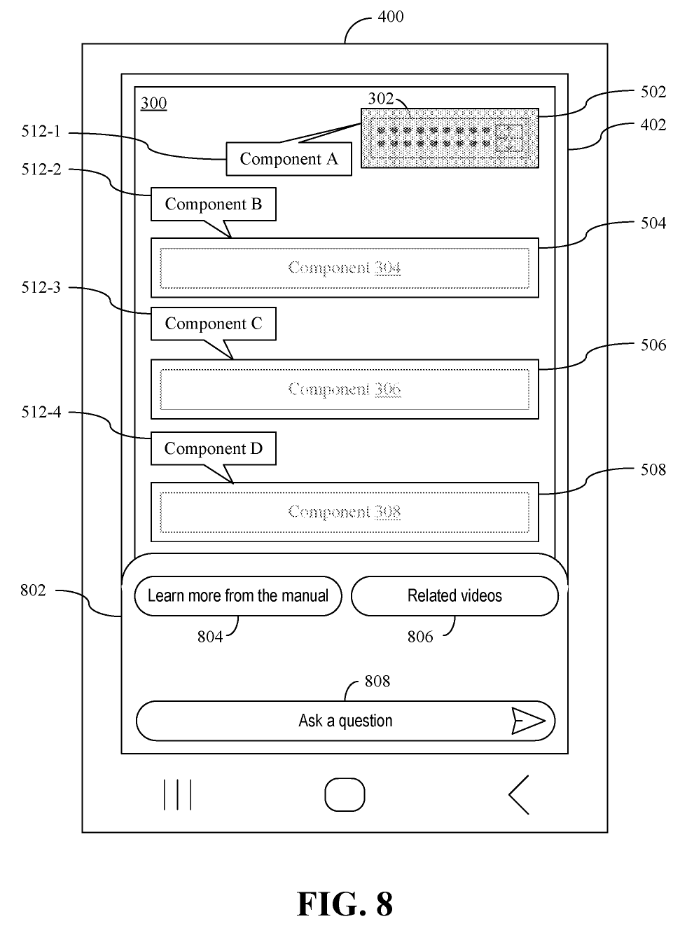

FIG. 8 illustrates an example state of device 400 subsequent to initiation of a troubleshooting session as described in connection with FIG. 7. In the example of FIG. 8, AR module 110 has updated the AR overlay to include a graphical user interface (GUI) 802 having GUI control 804, GUI control 806, and a user input field 808 through which the user may provide a user input via speech or text. In the example of FIG. 8, the user has the option to troubleshoot component 302 by selecting GUI control 804 to load and/or display the manual of component 302 and/or by selecting GUI control 806 to display or view videos relating to component 302. The user has the further option of entering questions directly into user input field 808.

It should be appreciated that while information obtained from VLM 108 is illustrated as being visually presented via an AR overlay and/or within certain GUI elements displayed on a display screen, in some examples, information from VLM result 146 may be provided to the user in the form of audio. For example, user interface 122 of retrieval system 104 may include a text-to-speech engine that is capable of generating computer-based speech/audio specifying the text of VLM result 146 and/or portions thereof.

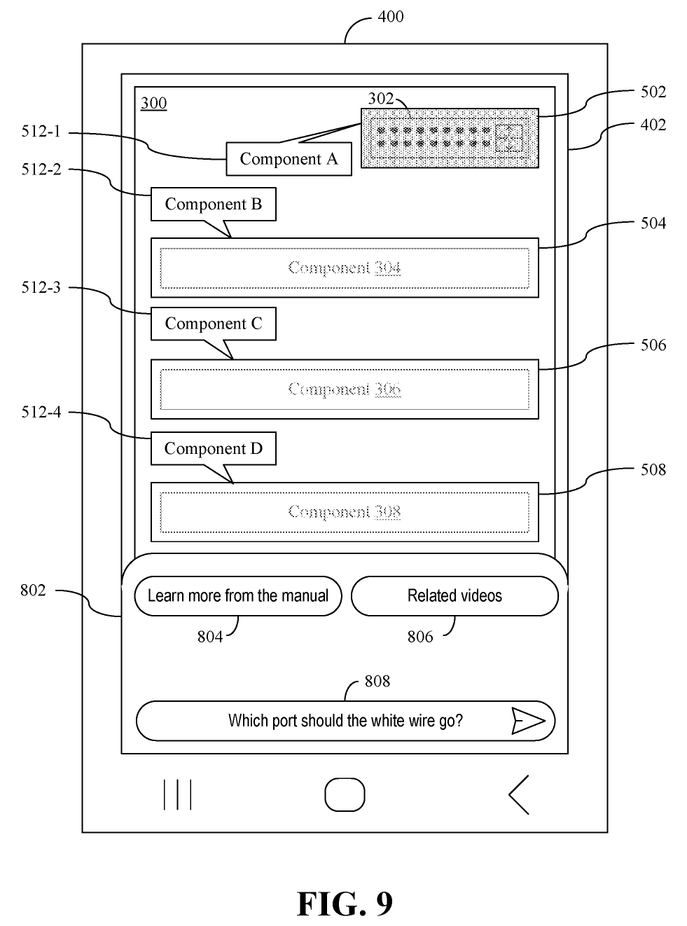

FIG. 9 illustrates an example state of device 400 in which the user is submitting a user input in the form of a question or query via user input field 808. In the example, the user asks the question “Which port should the wire go?” in reference to component 302. In the example, the user input may be provided to retrieval system 104, which may continue interacting with VLM 108. In doing so, the prior context relating to component 302 may be maintained so that any further questions, conversations, and/or images provided are evaluated for purposes of inference by VLM 108 in the context, e.g., as part of the same conversation, of troubleshooting component 302.

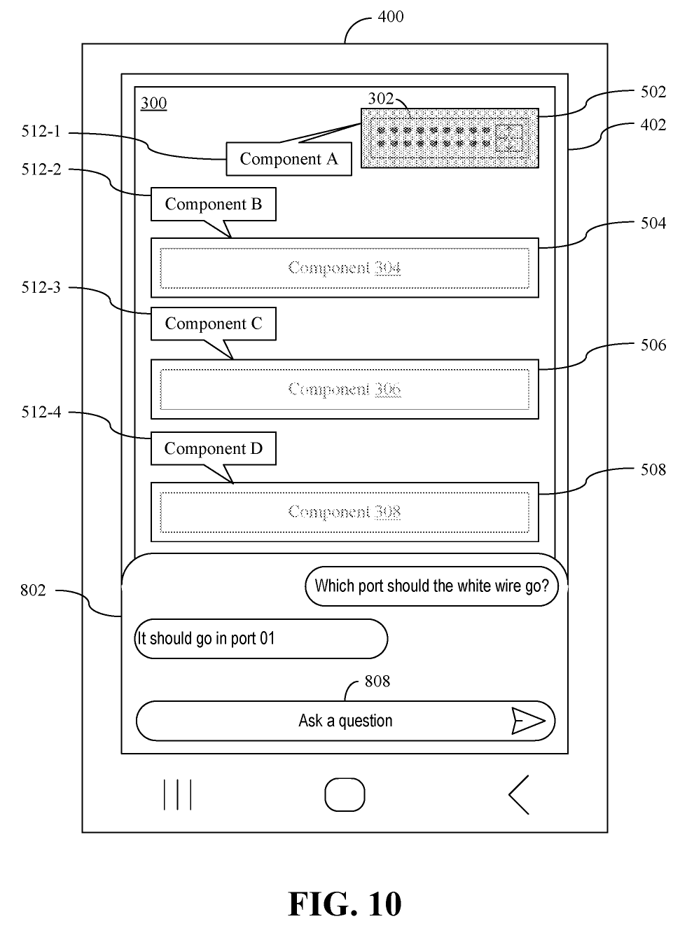

FIG. 10 illustrates an example state of device 400 subsequent to the user submitting the question as illustrated in FIG. 9. In the example, architecture 100 has obtained a result from VLM 108 that is displayed in GUI element 802. As illustrated, the user question is now illustrated as part of a chat conversation with VLM 108 and the response from VLM 108, i.e., “It should go in port 01,” is presented immediately below the user question. The user may continue to interact with VLM 108 via user input field 808.

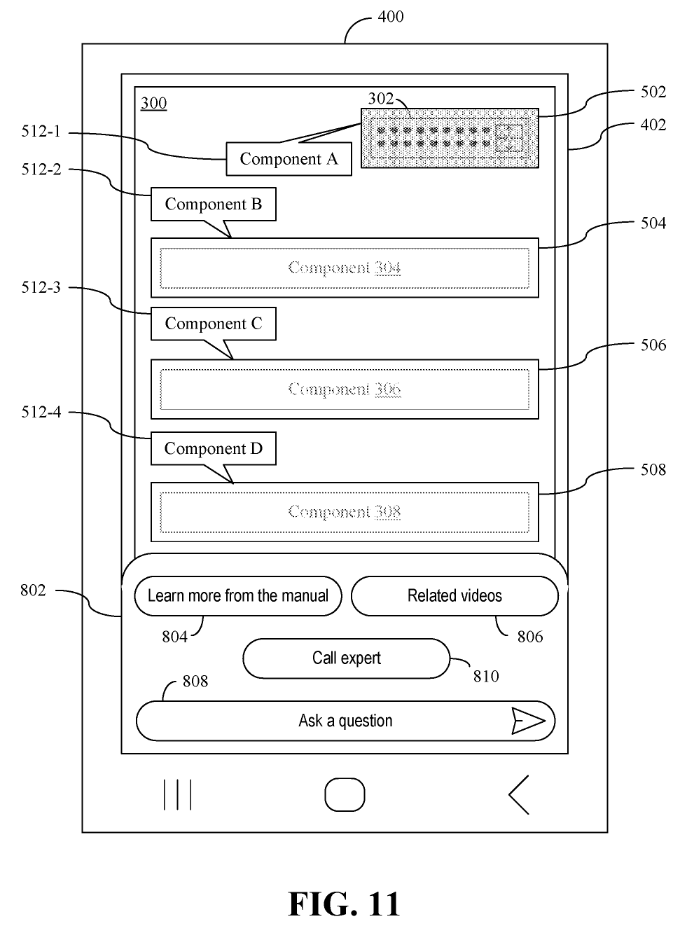

FIG. 11 illustrates another example state of device 400 in which a further GUI control 810 is illustrated. In the example, GUI control 810, when selected or activated, initiates a communication session with an expert. The expert is one with experience and/or expertise with the particular type of fault that is detected, with component 302, and/or with equipment 300. The communication session may be an interactive video communication session, e.g., a video call, initiated by communication subsystem 114.

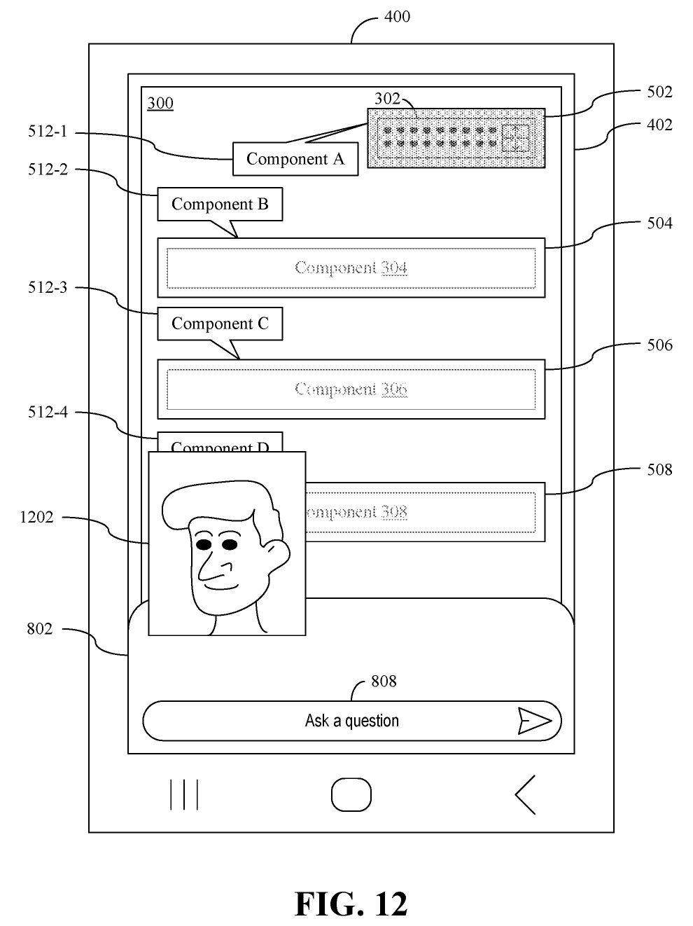

Returning to FIG. 2, in block 226, architecture 100, e.g., communication subsystem 114, optionally may establish a communication session with a communication device of an expert in response to a user request to do so. FIG. 12 illustrates an example state of device 400 in which the user has requested initiation of a communication session with an expert and device 400 has established the communication session. In the example, a further window 1202 is illustrated showing a live video feed of the expert in communication with the user.

In one or more example implementations, as part of the communication session, the camera feed and AR overlay 148 as displayed on display screen 402 of device 400 also may be fed to sent to the communication device of the expert. That is, device 400 may convey a view, and/or continually convey the view, of camera feed 130 and the AR overlay from display screen 402 of device 400 to the communication device of the expert for display on a display screen of the communication device of the expert. This allows the expert to experience, e.g., see and hear and access the same information, that is available to the user in troubleshooting component 302 in real-time and/or in substantially real-time. The expert may ascertain the state of equipment 300 and/or component 302 in having access to the same information in the same/similar time-frame as the user attempting to perform the diagnostic and cure the fault.

Block 228 may be performed after a user has taken action to address or correct the fault with component 302. The user, for example, may have followed guidance or instructions obtained from VLM 108, may have followed instructions from the expert in the case of a communication session having been established, or the like. In block 220, the user may capture an updated image or camera feed 130 that includes component 302. Architecture 100 may go through the process as described in terms of performing object detection to detect component 302 therein, generate a bounding box encompassing component 302 with an updated bounding box image for component 302, generating and submitting a knowledge base query, obtaining knowledge base results that may be included in a VLM request. The VLM request may include a further user input such as “is component 302 now fixed or functioning properly?” In this example, VLM 108 is configured to evaluate whether a detected fault with the object has been rectified based on the VLM request. In cases where status information for component 302 is also available, such information may be received and included in the VLM request. The VLM result indicates whether the user initiated corrective action cures the fault. In response to the VLM result indicating that component 302 is now fault free and operating normally, device 400 may indicate this state by presenting a visual indicator through the AR overlay (e.g., changing the visual indication such as color or texture to indicate that component 302 is in good working order – e.g., is fault free). In the case where component 302 is still experiencing faults, this condition also may be communicated to the user.

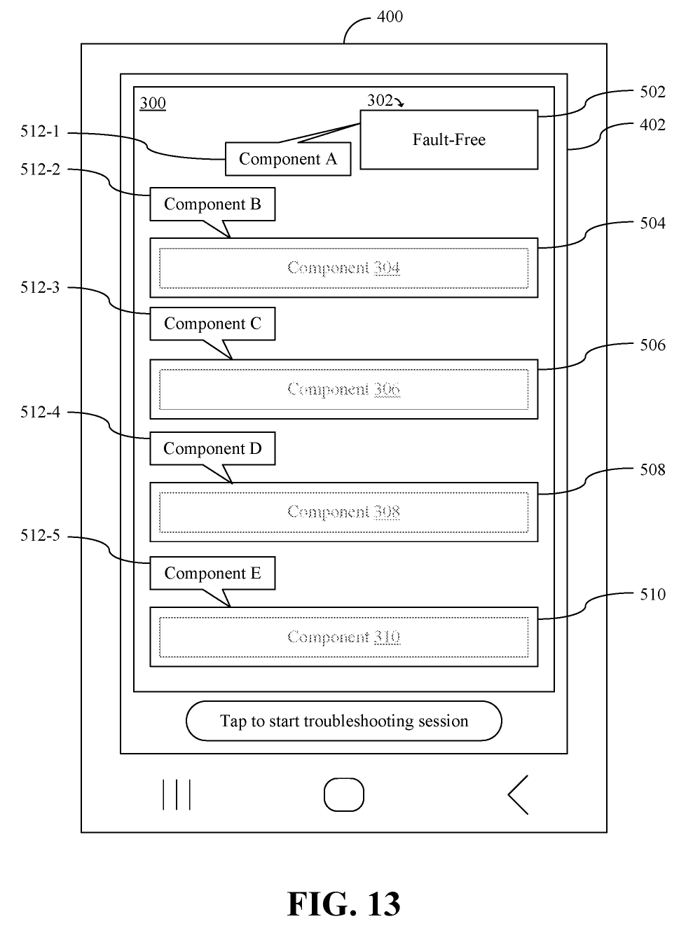

FIG. 13 illustrates an example state of device 400 subsequent to block 228. In the example, the AR overlay specifying bounding box 502 is updated to indicate “Fault Free,” e.g., that component 302 is now fault free. As noted, any of a variety of visual indicators may be used to convey this status, e.g., or change in status, of component 302 to the user. The status of being fault free also may be displayed in label 512-1, for example.

The disclosed technology is capable of providing multimodal guidance and support for a user to troubleshoot machinery and/or equipment. The guidance may be provided via an AR overlay that dynamically adapts to real-time component detection, AI-powered diagnostics, and user corrective actions. Rather than displaying static AR elements, architecture 100 may continually update the visual and textual guidance provided via the AR overlay in real-time based on the detected objects and/or issues, retrieved faulty/ideal configurations, and VLM-based analysis. For example, referring to FIG. 13, architecture 100 may initiate such action indicating that component 302 is fault free by continually performing the operations described in connection with FIG. 2 on an iterative basis without the user asking whether the fault has been resolved.

In one or more examples, the user may indicate whether the action taken to address the fault of component A was one suggested or provided by the VLM 108, one obtained from the expert, or another action determined by the user. This type of feedback may be used to enhance VLM 108. Further, the user may describe the particular action taken, when the action is one conceived of by the user as opposed to being a suggestion provided to the user, so that the action taken may be integrated into remote knowledge base 112 and synched to knowledge base 106 and/or integrated into training for VLM 108.

The disclosed technology may be incorporated into any of a variety of different environments and/or use cases. For example, the disclosed technology be used by workers to troubleshoot equipment in the context of an industrial and/or manufacturing environment. In another example, the user may use the device in the field. For example, a technician may use the disclosed technology embodied in a mobile device while making in-the-field service calls to consumers and/or customers. In still another example, the user may be a customer or lay person attempting to troubleshoot equipment such as an appliance in their home or place of work. In that case, the disclosed technology may operate as described allowing the consumer to work with an expert to troubleshoot the equipment.

FIG. 14 is an example of a device 400 that may include and/or execute architecture 100 of FIG. 1. Examples of device 400 may include a workstation, a desktop computer, a computer terminal, a mobile computer, a laptop computer, a netbook computer, a tablet computer, a smart phone, a personal digital assistant, a smart watch, smart glasses, a gaming device, a set-top box, a television (e.g., a digital television or DTV), a real-time playback system, a smart television, information appliance, streaming device coupled to a device having a screen, IoT device, server, a virtual reality (VR) system, an augmented reality (AR) system, a mixed reality (MR) system, an extended reality (XR) system, a metaverse system, a wearable device (e.g., smart glasses and/or goggles), or the like.

In the example, device 400 includes one or more hardware processors 1402. In one or more examples, hardware processor 1402 may be embodied as a central processing unit (CPU) that includes one or more cores, where each core is capable of executing computer-readable program instructions. Hardware processor 1402 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like. Though not illustrated, hardware processor 1402 also may include one or more hardware accelerators. Examples of hardware accelerators may include, but are not limited to, GPUs, DSPs, SoCs, FPGAs, ASICs, or the like.

In one or more other examples, hardware processor 1402 may be implemented as an SoC that is capable of implementing the various blocks of architecture 100 of FIG. 1 as hardware blocks (e.g., application-specific circuit blocks). In one or more other examples, hardware processor 1402 may be implemented as a combination of application-specific circuit blocks and/or cores capable of executing program code. In any case, architecture 100 is capable of performing the operations described herein.

Hardware processor 1402 is coupled to a physical memory 1404 via interconnect circuitry 1406. Physical memory 1404 may be embodied as one or more computer-readable storage mediums. Physical memory 1404 may include a volatile memory 1408 and a non-volatile memory 1410. Volatile memory 1408 may be embodied as random-access memory (RAM) and may include cache memory. Non-volatile memory 1410 may include a non-volatile magnetic medium and/or a solid-state medium.

In some example implementations, non-volatile memory 1410 may include one or more disk drives capable of reading from and writing to various types of removable, non-volatile mediums such as a removable, non-volatile magnetic disk (e.g., a "floppy disk") and/or a removable, non-volatile optical disk such as a CD-ROM, DVD-ROM or other optical media.

Examples of interconnect circuitry 1406 include, but are not limited to, an input/output (I/O) subsystem, an I/O interface, a communication bus, and a memory interface. For example, interconnect circuitry 1406 may be implemented as any of a variety of communication bus structures and/or combinations of communication bus structures including a memory bus or memory controller, a peripheral bus, a Peripheral Component Interconnect Express (PCIe) bus, on-chip interconnect, an accelerated graphics port, and a processor or local bus.

Device 400 may include a display screen 402. In one or more examples, display screen 402 is touch-enabled. In this regard, display screen 402 is capable of receiving touch or touch-based input from a user. Images and/or video, e.g., camera feed 130, and any AR overlay(s) generated may be rendered or displayed on display screen 402.

Device 400 may include an audio subsystem 1414. Audio subsystem 1414 can be coupled to interconnect circuitry 1406 directly or through a suitable input/output (I/O) controller. Audio subsystem 1414 can be coupled to a speaker 1416 and a microphone 1418 to facilitate voice-enabled functions such as receiving user input 142 as a user spoken utterance via microphone 1418 and playing audio content including audio generated from text specified by VLM result 146 through speaker 1416.

Device 400 may include a camera subsystem 1420 that may be coupled to an optical sensor 1422. Optical sensor 1422 may be implemented using any of a variety of technologies. Examples of optical sensor 1422 can include, but are not limited to, a charged coupled device (CCD), a complementary metal-oxide semiconductor (CMOS) optical sensor, or other type of camera and/or image capture system. Camera subsystem 1420 and optical sensor 1422 can be used to facilitate camera functions, such as recording images and/or video referred to herein as camera feed 130.

Device 400 may include a communication subsystem 114. Communication subsystem 114 can be coupled to interconnect circuitry 1406 directly or through a suitable I/O controller (not shown). Communication subsystem 114 is capable of facilitating communication functions. Examples of communication subsystem 114 can include, but are not limited to, wireless communication systems such as radio frequency receivers and transmitters, and optical (e.g., infrared) receivers and transmitters. The specific design and implementation of communication subsystem 114 can depend on the particular type of device 400 implemented and/or the communication network(s) over which device 400 is intended to operate. In one or more examples, communication subsystem 114 is capable of establishing a communication session with a communication device of an expert as described herein. In one or more other examples, communication subsystem 114 is capable of establishing a communication link with a particular component being troubleshooted, e.g., component 302.

Device 400 further may include one or more other input/output (I/O) devices 1426 coupled to interconnect circuitry 1406. I/O devices 1426 may be coupled to device 400, e.g., interconnect circuitry 1406, either directly or through intervening I/O controllers (not shown). Examples of I/O devices 1426 include, but are not limited to, a keyboard, one or more communication ports (e.g., Universal Serial Bus (USB) ports), a network adapter, sensors, and buttons or other physical controls.

A network adapter refers to circuitry that enables device 400 to become coupled to other systems, computer systems, remote printers, and/or remote storage devices through intervening private or public networks. Modems, cable modems, Ethernet interfaces, and are examples of different types of network adapters that may be used with device 400. Examples of sensors may include, but are not limited to, temperature sensors, light sensors, an accelerometer, a magnetometer, and/or an inertial measurement unit (IMU). Sensors may be connected to interface circuitry 1406 to provide sensor data that can be used to determine change of speed and direction of movement of a device (e.g., or of optical sensor 1422) in 3-dimensions for purposes of detecting and/or locating objects in camera feed 130.

Device 400 is provided an example of an electronic device or system that is capable of performing the various operations described within this disclosure and is not intended to be limiting. A device and/or system configured to perform the operations described herein may have a different architecture than illustrated in FIG. 14. The architecture may be a simplified version of the architecture described in connection with FIG. 14 or may be a more complex version of the architecture described in connection with FIG. 14. In this regard, device 400 may include fewer components than shown or additional components not illustrated in FIG. 14 depending upon the particular type of device that is implemented.

The terminology used herein is for the purpose of describing particular examples and implementations of the disclosed technology and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of computer readable storage mediums. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the terms “in response to” and “responsive to” mean responding or reacting readily to an action or event. Thus, if a second action is performed “in response to” or “responsive to” a first action, there is a causal relationship between an occurrence of the first action and an occurrence of the second action. The term "responsive to" indicates the causal relationship. In some cases, other terms such as “if,” “when,” or “upon” are used and also convey a causal relationship.

As defined herein, the term “hardware processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a Digital Signal Processor (DSP), a Graphics Processing Unit (GPU), and a controller.

As defined herein, the term “real-time” means a level of processing responsiveness that a user or system senses as sufficiently immediate for a particular process or determination to be made, or that enables the processor to keep up with some external process.

The term "substantially" means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or two or more, e.g., a plurality, of such mediums) having computer readable program instructions thereon for causing a processor to carry out aspects of the disclosed technology. Within this disclosure, the term “program code” is used interchangeably with the terms “computer readable program instructions” and “program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The descriptions of the various implementations of the disclosed technology have been presented for purposes of illustration and are not intended to be exhaustive or limited to the examples disclosed. Many modifications and variations will be apparent to those of ordinary skill in the art without departing from the scope and spirit of the described examples. The terminology used herein was chosen to best explain the principles of the disclosed technology, the practical application or technical improvement over other technologies found in the marketplace, or to enable others of ordinary skill in the art to understand the examples disclosed herein.

What is claimed is:

1. A method, comprising:
within a device, detecting an object in a camera feed concurrently with displaying the camera feed on a display screen of the device;
querying a knowledge base with a knowledge base query including a bounding box image of the object detected from the camera feed;
performing inference using a Vision Language Model (VLM) in response to a VLM request specifying the bounding box image of the object and a knowledge base result obtained from the knowledge base query, wherein the inference generates a VLM result; and
displaying, on the display screen of the device, an augmented reality (AR) overlay over the camera feed, wherein the AR overlay visually distinguishes the object within the camera feed and displays VLM information for the object specified by the VLM result.

2. The method of claim 1, wherein the knowledge base result included in the VLM request includes an image of the object in a normal configuration and an image of the object in a faulty configuration.

3. The method of claim 2, wherein the VLM is trained to compare the bounding box image of the object with the image of the object in the normal configuration and the image of the object in the faulty configuration.

4. The method of claim 2, further comprising:
submitting an updated bounding box image of the object to the VLM, wherein the updated bounding box image is obtained subsequent to a corrective action for the object;
wherein the VLM is configured to evaluate whether a detected fault with the object is rectified based on the updated bounding box image compared, at least in part, with the image of the object in the normal configuration and the image of the object in the faulty configuration.

5. The method of claim 1, wherein the knowledge base result included in the VLM request includes data extracted from one or more of a specification for the object or a manual for the object.

6. The method of claim 1, further comprising:
establishing a communication session between the device and a communication device of an expert user of the object; and
conveying, from the device, a view of the camera feed and the AR overlay from the display screen of the device to the communication device of the expert user for display on a display screen of the communication device.

7. The method of claim 1, further comprising:
establishing a communication link between the device and the object and obtaining status information from the object over the communication link.

8. The method of claim 7, further comprising performing at least one of:
displaying the status information as part of the AR overlay; or
including the status information in the VLM request submitted to the VLM.

9. The method of claim 1, further comprising:
receiving a user query directed to the object; and
including the user query within the VLM request.

10. A device, comprising:
a camera configured to generate a camera feed;
a display screen configured to display the camera feed;
an object detector configured to detect an object in the camera feed concurrently with display of the camera feed on the display screen, wherein the object detector generates a bounding box image of the object;
a retrieval system configured to query a knowledge base with a knowledge base query including the bounding box image of the object;
a Vision Language Model (VLM) configured to perform inference in response to a VLM request generated by the retrieval system to generate a VLM result, wherein the VLM request includes the bounding box image of the object and a knowledge base result obtained from the knowledge base query; and
an augmented reality (AR) module configured to display, on the display screen, an AR overlay over the camera feed, wherein the AR overlay visually distinguishes the object within the camera feed and displays VLM information for the object specified by the VLM result.

11. The device of claim 10, wherein the knowledge base result included in the VLM request includes an image of the object in a normal configuration and an image of the object in a faulty configuration.

12. The device of claim 11, wherein the VLM is trained to compare the bounding box image of the object with the image of the object in the normal configuration and the image of the object in the faulty configuration.

13. The device of claim 11, wherein the retrieval system is capable of:
submitting an updated bounding box image of the object to the VLM, wherein the updated bounding box image is obtained subsequent to a corrective action for the object;
wherein the VLM is configured to evaluate whether a detected fault with the object is rectified based on the updated bounding box image compared, at least in part, with the image of the object in the normal configuration and the image of the object in the faulty configuration.

14. The device of claim 10, wherein the knowledge base result included in the VLM request includes data extracted from one or more of a specification for the object or a manual for the object.

15. The device of claim 10, further comprising:
a communication subsystem capable of establishing a communication session between the device and a communication device of an expert user of the object;
wherein the communication subsystem is capable of conveying view of the camera feed and the AR overlay from the display screen of the device to the communication device of the expert user for display on a display screen of the communication device.

16. The device of claim 10, further comprising:
a communication subsystem capable of establishing a communication link between the device and the object and obtaining status information from the object over the communication link.

17. The device of claim 16, wherein the AR module is capable of performing at least one of:
displaying the status information as part of the AR overlay; or
including the status information in the VLM request submitted to the VLM.

18. The device of claim 10, wherein, in response to receiving a user input specifying a query directed to the object, the query is included in the VLM request.

19. A system, comprising:
a display screen;
a hardware processor; and
one or more computer-readable storage mediums configured to store a knowledge base and a Vision Language Model (VLM), wherein the one or more computer-readable storage mediums further have program instructions stored thereon to cause the hardware processor to perform operations comprising:
detecting an object in a camera feed concurrently with displaying the camera feed on the display screen;
querying the knowledge base with a knowledge base query including a bounding box image of the object detected from the camera feed;
performing inference using the VLM in response to a VLM request specifying the bounding box image of the object and a knowledge base result obtained from the knowledge base query, wherein the inference generates a VLM result; and
displaying, on the display screen, an augmented reality (AR) overlay over the camera feed, wherein the AR overlay visually distinguishes the object within the camera feed and displays VLM information for the object specified by the VLM result.

20. The system of claim 19, wherein the knowledge base result included in the VLM request includes an image of the object in a normal configuration and an image of the object in a faulty configuration.
